(19) United States
(12) Patent Application Publication
(10) Pub. No.: US 2025/0189762 A1
(43) Pub. Date: Jun. 12, 2025

(54) OPTICAL LENS ASSEMBLY AND ELECTRONIC DEVICE

(71) Applicant: NEWMAX TECHNOLOGY CO., LTD., Taichung City (TW)

(72) Inventor: Ruei-Tze HONG, Taichung City (TW)

(21) Appl. No.: 18/430,611

(22) Filed: Feb. 1, 2024

(30) Foreign Application Priority Data
Dec. 6, 2023 (TW) 112147356

(51) Int. Cl. G02B 13/00; G02B 9/10

(52) U.S. Cl. CPC G02B 13/003; G02B 9/10

(57) ABSTRACT

An optical lens assembly includes a stop, and in order from an object side to an image side, includes: a first lens with negative refractive power; a second lens with positive refractive power; wherein the optical lens assembly has a total of two lenses with refractive power, a radius of curvature of an object-side surface of the first lens is R1, a radius of curvature of an image-side surface of the first lens is R2, a radius of curvature of an image-side surface of the second lens is R4, and the following condition is satisfied: −1.45 mm<(R1/R4)*R2<−0.34 mm.

### BACKGROUND

### Field of the Invention

The present invention relates to an optical lens assembly and electronic device, and more particularly to an optical lens assembly applicable to electronic products.

### Description of Related Art

The biometric identification system based on the unique biometric characteristics of each organism has uniqueness, universality, permanence, testability, convenience, acceptability, and reliableness, so it is often used in existing mobile devices on the current market, or even in future electronic devices. However, the biometric identification system used in present mobile devices is based on the principle of capacitive sensing. Although capacitive sensing technology facilitates the reducing of the required volume of the biometric identification system, the circuit structure is too complex, which makes the manufacturing cost too high and also makes the relative unit price of the product higher.

Although there are traditional biometric identification systems using optical imaging principles, such as fingerprint identification, vein identification and so on, the traditional biometric identification systems have a too large volume, which makes the electronic devices equipped with the biometric identification systems difficult to be miniaturized and also harder to be carried.

The present invention mitigates and/or obviates the aforementioned disadvantages.

### SUMMARY

The objective of the present invention is to provide an optical lens assembly and an electronic device, and the optical lens assembly has a total of two lenses with refractive power. When a specific condition is satisfied, the optical lens assembly can achieve a compact size and enhance the image quality.

In addition, when the lens is made of glass, the optical lens assembly of the present invention can be used at more extreme temperatures.

Therefore, an optical lens assembly in accordance with an embodiment of the present invention includes a stop, in order from an object side to an image side, includes: a first lens with negative refractive power, including an object-side surface and an image-side surface, the image-side surface of the first lens being convex in a paraxial region thereof, and at least one of the object-side surface and the image-side surface of the first lens being aspheric; and a second lens with positive refractive power, including an object-side surface and an image-side surface, the object-side surface of the second lens being convex in a paraxial region thereof, the image-side surface of the second lens being convex in a paraxial region thereof, and at least one of the object-side surface and the image-side surface of the second lens being aspheric.

In the optical lens assembly, a focal length of the optical lens assembly is f, a f-number of the optical lens assembly is Fno, a maximum field of view of the optical lens assembly is FOV, a radius of curvature of the object-side surface of the first lens is R1, a radius of curvature of the image-side surface of the first lens is R2, a radius of curvature of the object-side surface of the second lens is R3, a radius of curvature of the image-side surface of the second lens is R4, an incident angle of a chief ray on an image plane at a maximum view angle of the optical lens assembly is CRA, a focal length of the first lens is f1, a distance from the image-side surface of the first lens to the stop along an optical axis is T1S, an Abbe number of the first lens is vd1, an Abbe number of the second lens is vd2, a thickness of the first lens along the optical axis is CT1, a distance from an object-side surface of a flat panel to the image plane along the optical axis is OTL, a distance from the flat panel to the first lens along the optical axis is TG1, and at least one of the following conditions is satisfied:

$$\begin{matrix}- 1.45 mm < {( R 1 / R 4 )}^{⋆} R 2 < - 0 \text{.34} mm ; \\ - 2.6 \; 0 < ( R 1 + R 2 ) / ( R 3 + R 4 ) < - 0 \text{.62} ; \\ 50.53 ° / mm < CRA / f < 86.49 ° / mm ; \\ 35.17 ° < {CRA}^{⋆} F n o < 90.89 ° ; \\ 33.47 ° < {( R 2 / f 1 )}^{⋆} F O V < 75.51 ° ; \\ - 4.7 \; 7 < R 3 / R 4 < - 1 \text{.95} ; \\ - 6.1 \; 8 < f 1 / T 1 S < - 3 \text{.54} ; \\ 89.58 < vd 1 + vd 2 < 134 \text{.37} ; \\ - 11. 58 mm < f {1}^{⋆} R 3 / CT 1 < - 4 \text{.10} mm ; \\ - 25. 27 < {( FOV / OTL )}^{⋆} R 2 < - 1 1.72 ; and \\ 61.43 ° < {( FOV / TG 1 )}^{⋆} R 3 < 105.4 ° .\end{matrix}$$

When −1.45 mm<(R1/R4)*R2<−0.34 mm is satisfied, it is conducive to correcting the aberration by the appropriate configuration of the radii of curvature.

When −2.60<(R1+R2)/(R3+R4)<−0.62 is satisfied, it is conducive to obtaining a large amount of incident light by the appropriate configuration of the radii of curvature and the lens shapes.

When 50.53°/mm<CRA/f<86.49°/mm is satisfied, it is conducive to meeting the incident angle of the chief ray on the image plane of the optical lens assembly.

When 35.17°<CRA*Fno<90.89° is satisfied, it is conducive to meeting the incident angle of the chief ray on the image plane of the optical lens assembly and achieving a large amount of incident light.

When 33.47°<(R2/f1)*FOV<75.51° is satisfied, it is conducive to correcting the aberration of the optical lens assembly by a better ratio design to enhance the image quality of the optical lens assembly.

When −4.77<R3/R4<−1.95 is satisfied, it is conducive to correcting the aberration by the appropriate configuration of the radii of curvature.

When −6.18<f1/T1S<−3.54 is satisfied, it is conductive to obtaining a large amount of incident light and improving the maximum view angle by the appropriate ratio design.

When 89.58<vd1+vd2<134.37 is satisfied, it is conducive to reducing the manufacturing cost by the appropriate selection of lens materials.

When −11.58 mm<f1*R3/CT1<−4.10 mm is satisfied, it is conducive to correcting the aberration by the appropriate ratio design.

When −25.27<(FOV/OTL)*R2<−11.72 is satisfied, it is conducive to achieving the wide field of view and the miniaturization of module by the appropriate ratio design.

When 61.43°<(FOV/TG1)*R3<105.40° is satisfied, it is conducive to achieving the large field of view and maintaining the image quality of the optical lens assembly by the appropriate ratio design.

Optionally, the optical lens assembly has a total of two lenses with refractive power.

Moreover, an imaging device in accordance with an embodiment of the present invention includes, in order from an object side to an image side: a flat panel, the aforementioned optical lens assembly, and an image sensor.

Furthermore, an electronic device in accordance with an embodiment of the present invention includes the aforementioned imaging device, a control unit electrically connected to the imaging device, and a storage unit electrically connected to the control unit.

The present invention will be presented in further details from the following descriptions with the accompanying drawings, which show, for purpose of illustrations only, the preferred embodiments in accordance with the present invention.

### BRIEF DESCRIPTION OF THE DRAWINGS

FIG. 1A is a schematic view of an optical lens assembly in accordance with a first embodiment of the present invention;

FIG. 1B is a schematic diagram showing, in order from left to right, the field curvature curve and the distortion curve of the first embodiment of the present invention;

FIG. 1C is a schematic view of an imaging device in accordance with the first embodiment of the present invention;

FIG. 2A is a schematic view of an optical lens assembly in accordance with a second embodiment of the present invention;

FIG. 2B is a schematic diagram showing, in order from left to right, the field curvature curve and the distortion curve of the second embodiment of the present invention;

FIG. 2C is a schematic view of an imaging device in accordance with the second embodiment of the present invention;

FIG. 3A is a schematic view of an optical lens assembly in accordance with a third embodiment of the present invention;

FIG. 3B is a schematic diagram showing, in order from left to right, the field curvature curve and the distortion curve of the third embodiment of the present invention;

FIG. 3C is a schematic view of an imaging device in accordance with the third embodiment of the present invention;

FIG. 4A is a schematic view of an optical lens assembly in accordance with a fourth embodiment of the present invention;

FIG. 4B is a schematic diagram showing, in order from left to right, the field curvature curve and the distortion curve of the fourth embodiment of the present invention;

FIG. 4C is a schematic view of an imaging device in accordance with the fourth embodiment of the present invention;

FIG. 5A is a schematic view of an optical lens assembly in accordance with a fifth embodiment of the present invention;

FIG. 5B is a schematic diagram showing, in order from left to right, the field curvature curve and the distortion curve of the fifth embodiment of the present invention;

FIG. 5C is a schematic view of an imaging device in accordance with the fifth embodiment of the present invention;

FIG. 6 is a schematic view of the imaging device mounted on an electronic device in accordance with the first embodiment of the present invention; and

FIG. 7 is a side schematic view of FIG. 6.

### DETAILED DESCRIPTION

### First Embodiment

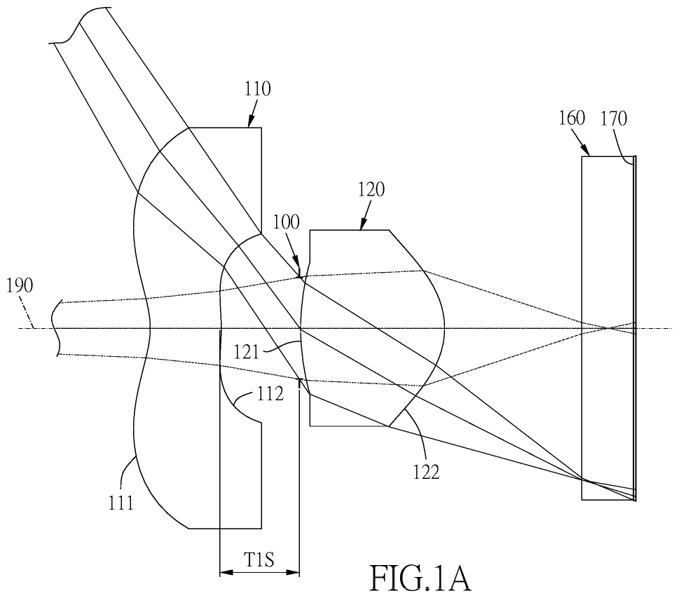

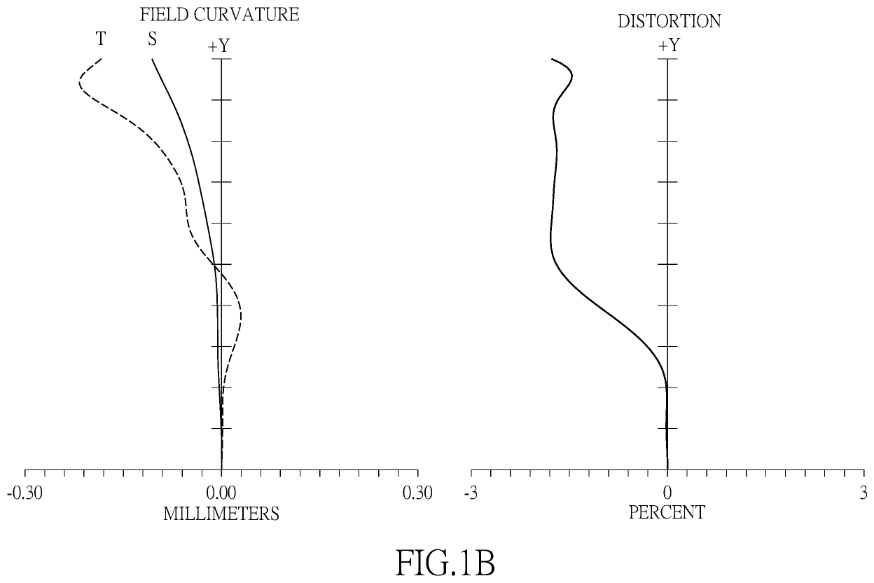

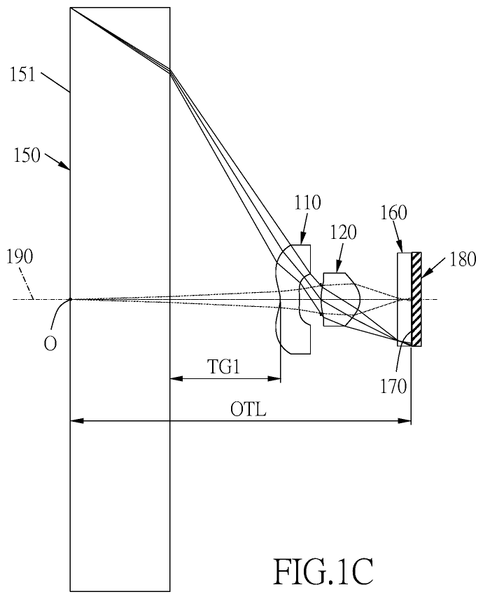

Referring to FIGS. 1A, 1B and 1C, FIG. 1A shows a schematic view of an optical lens assembly in accordance with a first embodiment of the present invention, FIG. 1B shows, in order from left to right, the field curvature curve and the distortion curve of the first embodiment of the present invention, and FIG. 1C shows a schematic view of an imaging device in accordance with the first embodiment of the present invention. As shown in FIG. 1A, the optical lens assembly includes, in order from an object side to an image side: a first lens 110, a stop 100, a second lens 120, an IR-cut filter 160, and an image plane 170. The optical lens assembly has a total of two lenses with refractive power (110, 120), but is not limited thereto. As shown in FIG. 1C, the imaging device includes, in order from an object side to an image side: a flat panel 150, the aforementioned optical lens assembly (not shown) and an image sensor 180 disposed on the image plane 170.

The flat panel 150 is made of glass, is located between an object O and the first lens 110, and has no influence on the focal length of the optical lens assembly. It is understood that the flat panel 150 may be made of other materials.

The first lens 110 with negative refractive power includes an object-side surface 111 and an image-side surface 112, the object-side surface 111 of the first lens 110 is concave in a paraxial region thereof, the image-side surface 112 of the first lens 110 is convex in a paraxial region thereof, the object-side surface 111 and the image-side surface 112 of the first lens 110 are aspheric, and the first lens 110 is made of plastic.

The second lens 120 with positive refractive power includes an object-side surface 121 and an image-side surface 122, the object-side surface 121 of the second lens 120 is convex in a paraxial region thereof, the image-side surface 122 of the second lens 120 is convex in a paraxial region thereof, the object-side surface 121 and the image-side surface 122 of the second lens 120 are aspheric, and the second lens 120 is made of plastic.

The IR-cut filter 160 is made of glass, is located between the second lens 120 and the image plane 170, and has no influence on the focal length of the optical lens assembly.

The curve equation for the aspheric surface profiles of the respective lenses of the first embodiment is expressed as follows:

$$z ( h ) = \frac{{ch}^{2}}{1 + {[ 1 - ( k + 1 ) {c}^{2} {h}^{2} ]}^{0.5}} + \sum ( {A}_{i} \cdot ( {h}^{i} )$$

wherein:
z represents the value of a reference position at a height of h with respect to a vertex of the surface of a lens along an optical axis 190;
c represents a paraxial curvature (i.e., a curvature of a lens surface in a paraxial region thereof) equal to 1/R (R: a paraxial radius of curvature);
h represents a vertical distance from the point on the curve of the aspheric surface to the optical axis 190;
k represents the conic constant; and
Ai represents the i-th order aspheric coefficient.

In the first embodiment of the optical lens assembly, a focal length of the optical lens assembly is f, a f-number of the optical lens assembly is Fno, a maximum field of view of the optical lens assembly is FOV, an incident angle of a chief ray on the image plane 170 at a maximum view angle of the optical lens assembly is CRA, and their values are expressed as follows: f=0.45 mm; Fno=1.54; FOV-119.08 degrees; and CRA=28.63 degrees.

In the first embodiment of the optical lens assembly, a radius of curvature of the object-side surface 111 of the first lens 110 is R1, a radius of curvature of the image-side surface 112 of the first lens 110 is R2, a radius of curvature of the image-side surface 122 of the second lens 120 is R4, and the following condition is satisfied:

$${( R 1 / R 4 )}^{⋆} R 2 = - 0 \text{.95} mm .$$

In the first embodiment of the optical lens assembly, the radius of curvature of the object-side surface 111 of the first lens 110 is R1, the radius of curvature of the image-side surface 112 of the first lens 110 is R2, a radius of curvature of the object-side surface 121 of the second lens 120 is R3, the radius of curvature of the image-side surface 122 of the second lens 120 is R4, and the following condition is satisfied:

$$( R 1 + R 2 ) / ( R 3 + R 4 ) = - 1.95 .$$

In the first embodiment of the optical lens assembly, the incident angle of the chief ray on the image plane 170 at the maximum view angle of the optical lens assembly is CRA, the focal length of the optical lens assembly is f, and the following condition is satisfied: CRA/f=63.16°/mm.

In the first embodiment of the optical lens assembly, the incident angle of the chief ray on the image plane 170 at the maximum view angle of the optical lens assembly is CRA, the f-number of the optical lens assembly is Fno, and the following condition is satisfied: CRA*Fno=43.96°.

In the first embodiment of the optical lens assembly, the radius of curvature of the image-side surface 112 of the first lens 110 is R2, a focal length of the first lens 110 is f1, the maximum field of view of the optical lens assembly is FOV, and the following condition is satisfied: (R2/f1)*FOV=64.68°.

In the first embodiment of the optical lens assembly, the radius of curvature of the object-side surface 121 of the second lens 120 is R3, the radius of curvature of the image-side surface 122 of the second lens 120 is R4, and the following condition is satisfied: R3/R4=−2.77.

In the first embodiment of the optical lens assembly, the focal length of the first lens 110 is f1, a distance from the image-side surface 112 of the first lens 110 to the stop 100 along the optical axis 190 is T1S, and the following condition is satisfied: f1/T1S=−5.12.

In the first embodiment of the optical lens assembly, an Abbe number of the first lens 110 is vd1, an Abbe number of the second lens 120 is vd2, and the following condition is satisfied: vd1+vd2=111.97.

In the first embodiment of the optical lens assembly, the focal length of the first lens 110 is f1, the radius of curvature of the object-side surface 121 of the second lens 120 is R3, a thickness of the first lens 110 along the optical axis 190 is CT1, and the following condition is satisfied: f1*R3/CT1=−5.92 mm.

In the first embodiment of the optical lens assembly, the radius of curvature of the image-side surface 112 of the first lens 110 is R2, the maximum field of view of the optical lens assembly is FOV, a distance from an object-side surface 151 of the flat panel 150 to the image plane 170 along the optical axis 190 is OTL, and the following condition is satisfied: (FOV/OTL)*R2=−20.71.

In the first embodiment of the optical lens assembly, the maximum field of view of the optical lens assembly is FOV, a distance from the flat panel 150 to the first lens 110 along the optical axis 190 is TG1, the radius of curvature of the object-side surface 121 of the second lens 120 is R3, and the following condition is satisfied: (FOV/TG1)*R3=74.19°.

Please refer to Tables 1-2. The detailed optical data of the respective elements in the optical lens assembly of the first embodiment is shown in Table 1, and the aspheric coefficients of the lenses in the first embodiment are shown in Table 2.

TABLE 1
Embodiment 1
f = 0.45 mm, Fno = 1.54, FOV = 119.08°

| | | | | | | | Abbe | |
|---|---|---|---|---|---|---|---|---|
| | | Radius of | | | | Refractive | number | Focal |
| Surface | | curvature | | Thickness/gap | Material | index (nd) | (vd) | length |
| 0 | Object | Infinity | | 0.000 | | | | |
| 1 | Flat panel | Infinity | | 1.500 | Glass | 1.52 | 64.2 | |
| 2 | | Infinity | | 1.664 | | | | |
| 3 | First lens | −0.397 | (ASP) | 0.288 | Plastic | 1.54 | 56.0 | −1.65 |
| 4 | | −0.893 | (ASP) | 0.321 | | | | |
| 5 | Stop | Infinity | | 0.006 | | | | |
| 6 | Second | 1.037 | (ASP) | 0.587 | Plastic | 1.54 | 56.0 | 0.59 |
| | lens | | | | | | | |
| 7 | | −0.374 | (ASP) | 0.560 | | | | |

| | | | | | | |
|---|---|---|---|---|---|---|
| 8 | IR-cut filter | Infinity | 0.210 | Glass | 1.52 | 64.2 |
| 9 | | Infinity | 0 | | | |
| 10 | Image | Infinity | — | | | |
| | plane | | | | | |

The reference wavelength is 530 nm.

TABLE 2
Embodiment 1
Aspheric Coefficients

| Surface | 3 | 4 | 6 | 7 |
|---|---|---|---|---|
| K: | 0.0000E+00 | 0.0000E+00 | 0.0000E+00 | 0.0000E+00 |
| A2: | 0.0000E+00 | 0.0000E+00 | 0.0000E+00 | 0.0000E+00 |
| A4: | 1.9191E+00 | 5.0891E+00 | −8.2987E+00 | −6.3368E−01 |
| A6: | −5.7575E+00 | 9.7755E+01 | 3.9336E+02 | 4.8221E+01 |
| A8: | 1.2315E+01 | −3.1929E+03 | −1.1852E+04 | −1.0031E+03 |
| A10: | −1.0974E+01 | 4.5744E+04 | 1.1311E+05 | 1.1899E+04 |
| A12: | −9.6763E+00 | −3.1790E+05 | 1.1149E+06 | −7.2225E+04 |
| A14: | 2.6676E+01 | 7.9854E+05 | −1.4778E+07 | 1.8204E+05 |
| A16: | −4.4896E+00 | 1.9771E+06 | −3.2172E+08 | 3.6552E+05 |
| A18: | −2.2929E+01 | −1.3389E+07 | 5.6299E+09 | −3.6763E+06 |
| A20: | 1.3901E+01 | 1.6694E+07 | −2.3590E+10 | 7.2060E+06 |
| A22: | 0.0000E+00 | 0.0000E+00 | 0.0000E+00 | 0.0000E+00 |
| A24: | 0.0000E+00 | 0.0000E+00 | 0.0000E+00 | 0.0000E+00 |

In Table 1, the units of the radius of curvature, the thickness, the gap and the focal length are expressed in mm, and the surface numbers 0-10 respectively represent the surfaces from the object-side to the image-side, wherein the surface 0 represents a gap between the object O and the object-side surface 151 of the flat panel 150; the surface 1 represents the thickness of the flat panel 150 along the optical axis 190; the surface 2 represents a gap between the flat panel 150 and the first lens 110; the surface 3 represents the thickness of the first lens 110 along the optical axis 190; the surface 4 represents a gap between the first lens 110 and the stop 100; the surface 5 represents a gap between the stop 100 and the object-side surface 121 of the second lens 120; the surface 6 represents the thickness of the second lens 120 along the optical axis 190; the surface 7 represents a gap between the second lens 120 and the IR-cut filter 160; the surface 8 represents the thickness of the IR-cut filter 160 along the optical axis 190; the surface 9 represents a gap between the IR-cut filter 160 and the image plane 170; and the surface 10 represents the image plane 170. In table 2, k represents the conic constant of the equation of aspheric surface profiles, and A2, A4, A6, A8, A10, A12, A14, A16, A18, A20, A22, and A24 represent the high-order aspheric coefficients. The respective tables presented below for respective one of other embodiments are based on the schematic view of this embodiment, and the definitions of parameters in the tables are the same as those in Tables 1-2 of the first embodiment. Therefore, an explanation in this regard will not be provided again.

### Second Embodiment

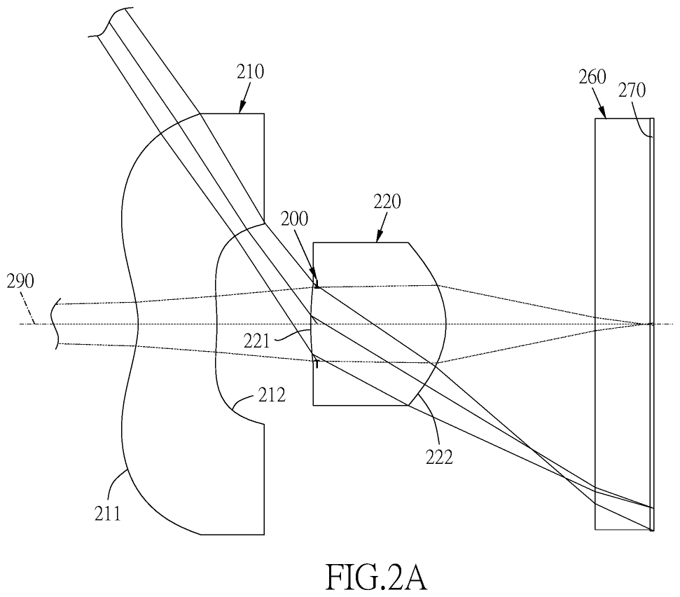

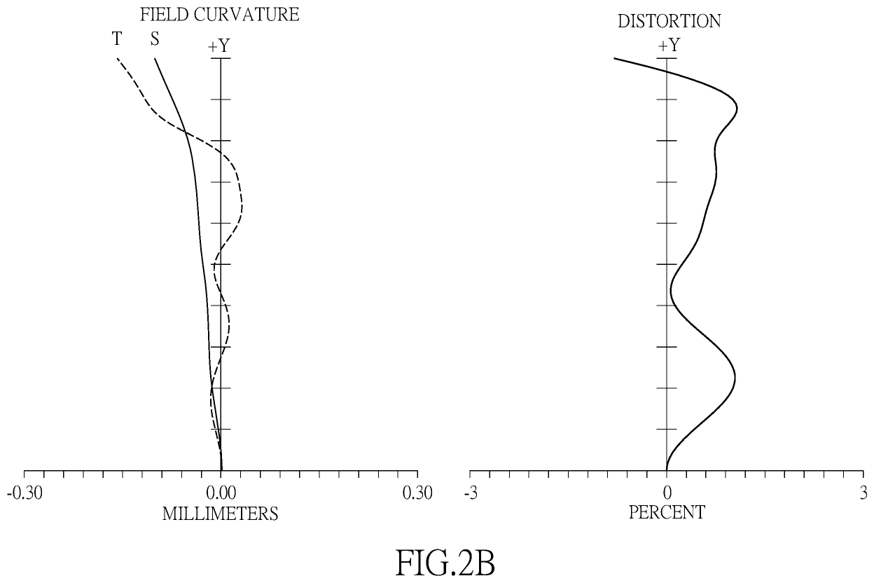

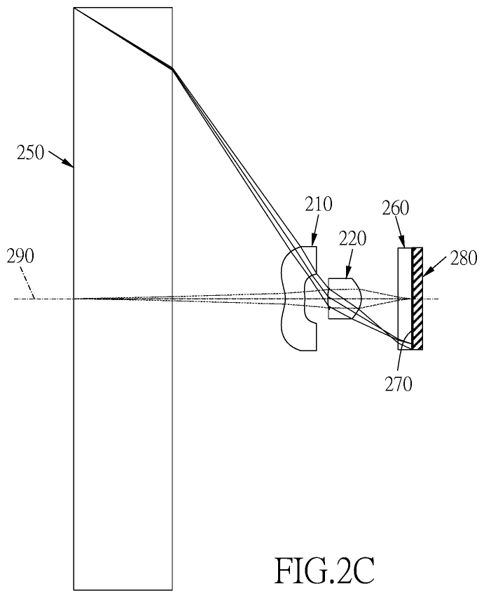

Referring to FIGS. 2A, 2B and 2C, FIG. 2A shows a schematic view of an optical lens assembly in accordance with a second embodiment of the present invention, FIG. 2B shows, in order from left to right, the field curvature curve and the distortion curve of the second embodiment of the present invention, and FIG. 2C shows a schematic view of an imaging device in accordance with the second embodiment of the present invention. As shown in FIG. 2A, the optical lens assembly includes, in order from an object side to an image side: a first lens 210, a stop 200, a second lens 220, an IR-cut filter 260, and an image plane 270. The optical lens assembly has a total of two lenses with refractive power (210, 220), but is not limited thereto. As shown in FIG. 2C, the imaging device includes, in order from an object side to an image side: a flat panel 250, the aforementioned optical lens assembly (not shown) and an image sensor 280 disposed on the image plane 270.

The flat panel 250 is made of glass, is located between an object O and the first lens 210, and has no influence on the focal length of the optical lens assembly. It is understood that the flat panel 250 may be made of other materials.

The first lens 210 with negative refractive power includes an object-side surface 211 and an image-side surface 212, the object-side surface 211 of the first lens 210 is concave in a paraxial region thereof, the image-side surface 212 of the first lens 210 is convex in a paraxial region thereof, the object-side surface 211 and the image-side surface 212 of the first lens 210 are aspheric, and the first lens 210 is made of plastic.

The second lens 220 with positive refractive power includes an object-side surface 221 and an image-side surface 222, the object-side surface 221 of the second lens 220 is convex in a paraxial region thereof, the image-side surface 222 of the second lens 220 is convex in a paraxial region thereof, the object-side surface 221 and the image-side surface 222 of the second lens 220 are aspheric, and the second lens 220 is made of plastic.

The IR-cut filter 260 is made of glass, is located between the second lens 220 and the image plane 270, and has no influence on the focal length of the optical lens assembly.

Please refer to Tables 3-4. The detailed optical data of the respective elements in the optical lens assembly of the second embodiment is shown in Table 3, and the aspheric coefficients of the lenses in the second embodiment are shown in Table 4.

TABLE 3
Embodiment 2
f = 0.46 mm, Fno = 2.30, FOV = 115.00°

| | | | | | | | Abbe | |
|---|---|---|---|---|---|---|---|---|
| | | Radius of | | Thickness/ | | Refractive | number | Focal |
| Surface | | curvature | | gap | Material | index (nd) | (vd) | length |
| 0 | Object | Infinity | | 0.000 | | | | |
| 1 | Flat panel | Infinity | | 1.500 | Glass | 1.52 | 64.2 | |
| 2 | | Infinity | | 1.715 | | | | |
| 3 | First lens | −0.441 | (ASP) | 0.295 | Plastic | 1.54 | 56.0 | −1.72 |
| 4 | | −1.026 | (ASP) | 0.375 | | | | |
| 5 | Stop | Infinity | | −0.023 | | | | |
| 6 | Second | 1.053 | (ASP) | 0.506 | Plastic | 1.54 | 56.0 | 0.58 |
| | lens | | | | | | | |
| 7 | | −0.376 | (ASP) | 0.560 | | | | |

| | | | | | | |
|---|---|---|---|---|---|---|
| 8 | IR-cut filter | Infinity | 0.210 | Glass | 1.52 | 64.2 |
| 9 | | Infinity | 0 | | | |
| 10 | Image | Infinity | — | | | |
| | plane | | | | | |

The reference wavelength is 530 nm.

TABLE 4
Embodiment 2
Aspheric Coefficients

| Surface | 3 | 4 | 6 | 7 |
|---|---|---|---|---|
| K: | 0.0000E+00 | 0.0000E+00 | 0.0000E+00 | 0.0000E+00 |
| A2: | 0.0000E+00 | 0.0000E+00 | 0.0000E+00 | 0.0000E+00 |
| A4: | 1.9636E+00 | 4.9263E+00 | −8.6130E+00 | −6.7330E−01 |
| A6: | −5.6702E+00 | 9.4669E+01 | 3.9530E+02 | 4.7673E+01 |
| A8: | 1.2379E+01 | −3.1620E+03 | −1.1705E+04 | −1.0020E+03 |
| A10: | −1.0955E+01 | 4.5874E+04 | 1.1645E+05 | 1.1976E+04 |
| A12: | −9.6612E+00 | −3.1730E+05 | 1.3761E+06 | −7.1165E+04 |
| A14: | 2.6715E+01 | 8.0082E+05 | −4.6826E+06 | 1.9056E+05 |
| A16: | −4.3980E+00 | 1.9872E+06 | 6.1832E+06 | 4.1985E+05 |
| A18: | −2.2640E+01 | −1.3358E+07 | 2.2704E+10 | −3.6798E+06 |
| A20: | 1.4419E+01 | 1.6848E+07 | 8.3266E+11 | −2.6976E+06 |
| A22: | 0.0000E+00 | 0.0000E+00 | 0.0000E+00 | 0.0000E+00 |
| A24: | 0.0000E+00 | 0.0000E+00 | 0.0000E+00 | 0.0000E+00 |

In the second embodiment, the curve equation of the aspheric surface profiles of the aforementioned lenses is the same as the curve equation of the first embodiment. Also, the definitions of these parameters shown in the following table are the same as those stated in the first embodiment, so an explanation in this regard will not be provided again.

These parameters can be calculated from Tables 3-4 as the following values, and the following conditions in Table 5 are satisfied.

TABLE 5
Embodiment 2

| | | | |
|---|---|---|---|
| (R1/R4)*R2[mm] | −1.20 | R3/R4 | −2.80 |
| (R1 + R2)/(R3 + R4) | −2.17 | (FOV/OTL)*R2 | −22.97 |
| CRA/f[°/mm] | 72.08 | f1/T1S | −4.58 |
| CRA*Fno[°] | 75.74 | vd1 + vd2 | 111.97 |
| (R2/f1)*FOV[°] | 68.65 | f1*R3/CT1[mm] | −6.14 |
| (FOV/TG1)*R3[°] | 70.61 | CRA[°] | 32.93 |

### Third Embodiment

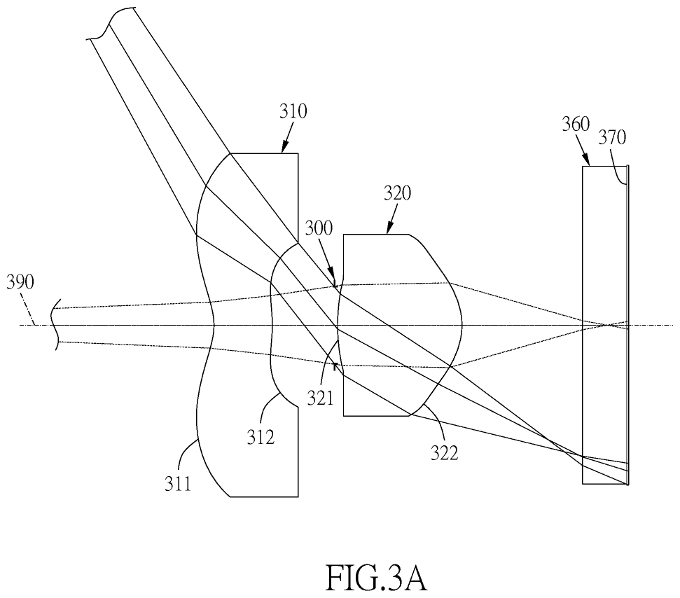

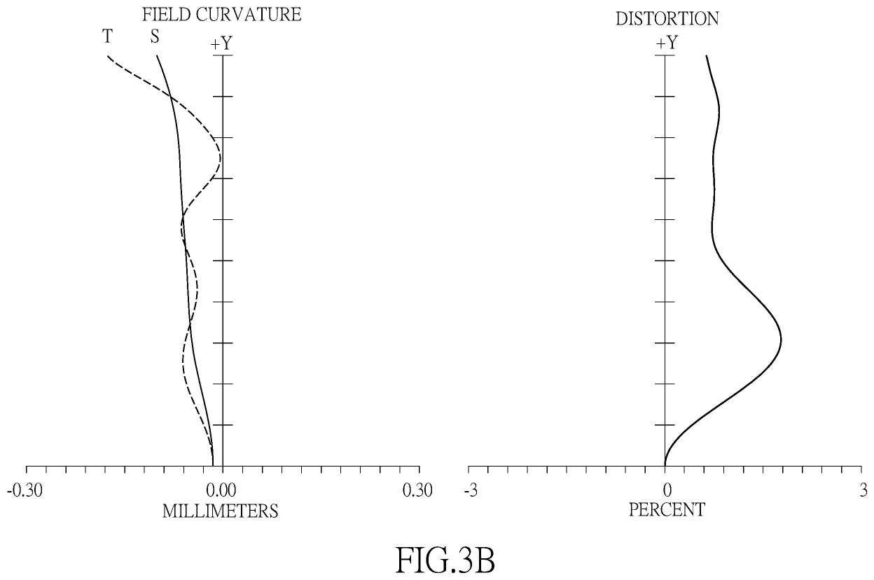

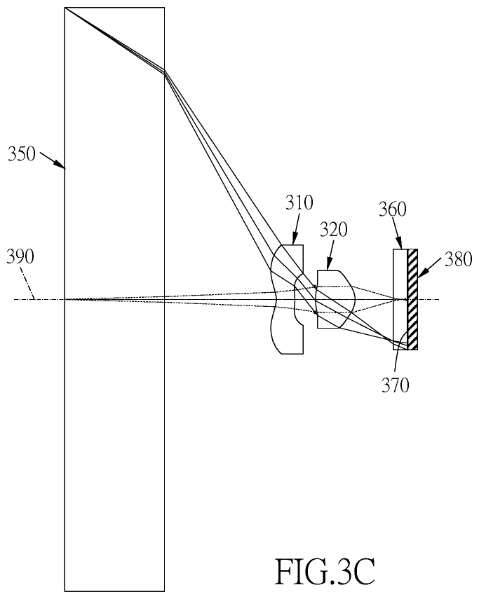

Referring to FIGS. 3A, 3B and 3C, FIG. 3A shows a schematic view of an optical lens assembly in accordance with a third embodiment of the present invention, FIG. 3B shows, in order from left to right, the field curvature curve and the distortion curve of the third embodiment of the present invention, and FIG. 3C shows a schematic view of an imaging device in accordance with the third embodiment of the present invention. As shown in FIG. 3A, the optical lens assembly includes, in order from an object side to an image side: a first lens 310, a stop 300, a second lens 320, an IR-cut filter 360, and an image plane 370. The optical lens assembly has a total of two lenses with refractive power (310, 320), but is not limited thereto. As shown in FIG. 3C, the imaging device includes, in order from an object side to an image side: a flat panel 350, the aforementioned optical lens assembly (not shown) and an image sensor 380 disposed on the image plane 370.

The flat panel 350 is made of glass, is located between an object O and the first lens 310, and has no influence on the focal length of the optical lens assembly. It is understood that the flat panel 350 may be made of other materials.

The first lens 310 with negative refractive power includes an object-side surface 311 and an image-side surface 312, the object-side surface 311 of the first lens 310 is concave in a paraxial region thereof, the image-side surface 312 of the first lens 310 is convex in a paraxial region thereof, the object-side surface 311 and the image-side surface 312 of the first lens 310 are aspheric, and the first lens 310 is made of plastic.

The second lens 320 with positive refractive power includes an object-side surface 321 and an image-side surface 322, the object-side surface 321 of the second lens 320 is convex in a paraxial region thereof, the image-side surface 322 of the second lens 320 is convex in a paraxial region thereof, the object-side surface 321 and the image-side surface 322 of the second lens 320 are aspheric, and the second lens 320 is made of plastic.

The IR-cut filter 360 is made of glass, is located between the second lens 320 and the image plane 370, and has no influence on the focal length of the optical lens assembly.

Please refer to Tables 6-7. The detailed optical data of the respective elements in the optical lens assembly of the third embodiment is shown in Table 6, and the aspheric coefficients of the lenses in the third embodiment are shown in Table 7.

TABLE 6
Embodiment 3
f = 0.44 mm, Fno = 1.70, FOV = 121.96°

| | | | | | | | Abbe | |
|---|---|---|---|---|---|---|---|---|
| | | Radius of | | | | Refractive | number | Focal |
| Surface | | curvature | | Thickness/gap | Material | index (nd) | (vd) | length |
| 0 | Object | Infinity | | 0.000 | | | | |
| 1 | Flat panel | Infinity | | 1.500 | Glass | 1.52 | 64.2 | |
| 2 | | Infinity | | 1.684 | | | | |
| 3 | First lens | −0.310 | (ASP) | 0.277 | Plastic | 1.54 | 56.0 | −1.51 |
| 4 | | −0.653 | (ASP) | 0.297 | | | | |
| 5 | Stop | Infinity | | 0.014 | | | | |
| 6 | Second | 0.943 | (ASP) | 0.593 | Plastic | 1.54 | 56.0 | 0.59 |
| | lens | | | | | | | |
| 7 | | −0.386 | (ASP) | 0.575 | | | | |

| | | | | | | |
|---|---|---|---|---|---|---|
| 8 | IR-cut filter | Infinity | 0.210 | Glass | 1.52 | 64.2 |
| 9 | | Infinity | 0 | | | |
| 10 | Image | Infinity | — | | | |
| | plane | | | | | |

The reference wavelength is 530 nm.

TABLE 7
Embodiment 3
Aspheric Coefficients

| Surface | 3 | 4 | 6 | 7 |
|---|---|---|---|---|
| K: | 0.0000E+00 | 0.0000E+00 | 0.0000E+00 | 0.0000E+00 |
| A2: | 0.0000E+00 | 0.0000E+00 | 0.0000E+00 | 0.0000E+00 |
| A4: | 1.8846E+00 | 4.4544E+00 | −7.7322E+00 | −1.1040E+00 |
| A6: | −5.8015E+00 | 1.0071E+02 | 3.2355E+02 | 5.6659E+01 |
| A8: | 1.2362E+01 | −3.2012E+03 | −1.1027E+04 | −9.3408E+02 |
| A10: | −1.0972E+01 | 4.5710E+04 | 1.2513E+05 | 1.1535E+04 |
| A12: | −9.7358E+00 | −3.1813E+05 | 1.1145E+06 | −7.5023E+04 |
| A14: | 2.6548E+01 | 7.9715E+05 | −1.6879E+07 | 1.9110E+05 |
| A16: | −4.6223E+00 | 1.9759E+06 | −3.4985E+08 | 3.6942E+05 |
| A18: | −2.3091E+01 | −1.3341E+07 | 5.2386E+09 | −3.3159E+06 |
| A20: | 1.4346E+01 | 1.6074E+07 | −2.4286E+10 | 5.5518E+06 |
| A22: | 0.0000E+00 | 0.0000E+00 | 0.0000E+00 | 0.0000E+00 |
| A24: | 0.0000E+00 | 0.0000E+00 | 0.0000E+00 | 0.0000E+00 |

In the third embodiment, the curve equation of the aspheric surface profiles of the aforementioned lenses is the same as the curve equation of the first embodiment. Also, the definitions of these parameters shown in the following table are the same as those stated in the first embodiment, so an explanation in this regard will not be provided again.

These parameters can be calculated from Tables 6-7 as the following values, and the following conditions in Table 8 are satisfied.

TABLE 8
Embodiment 3

| | | | |
|---|---|---|---|
| (R1/R4)*R2[mm] | −0.52 | R3/R4 | −2.44 |
| (R1 + R2)/(R3 + R4) | −1.73 | (FOV/OTL)*R2 | −15.46 |
| CRA/f[°/mm] | 66.07 | f1/T1S | −5.08 |
| CRA*Fno[°] | 49.63 | vd1 + vd2 | 111.97 |
| (R2/f1)*FOV[º] | 52.78 | f1*R3/CT1[mm] | −5.13 |
| (FOV/TG1)*R3[°] | 68.25 | CRA[°] | 29.19 |

### Fourth Embodiment

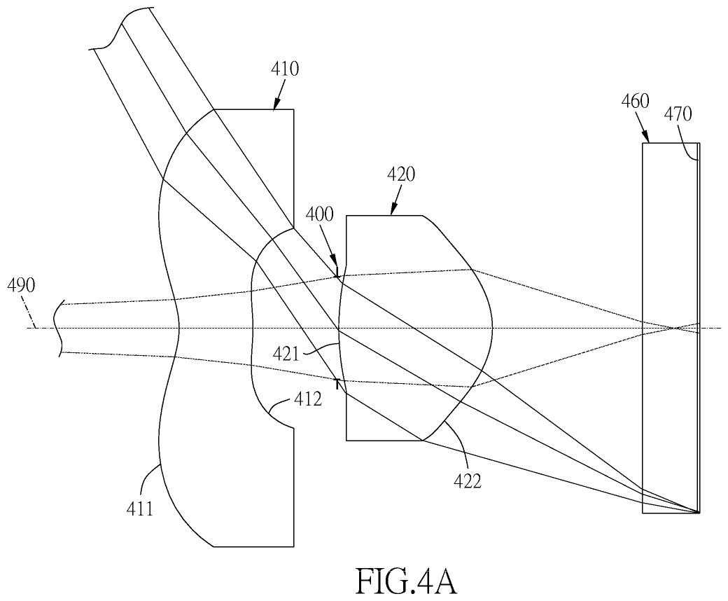

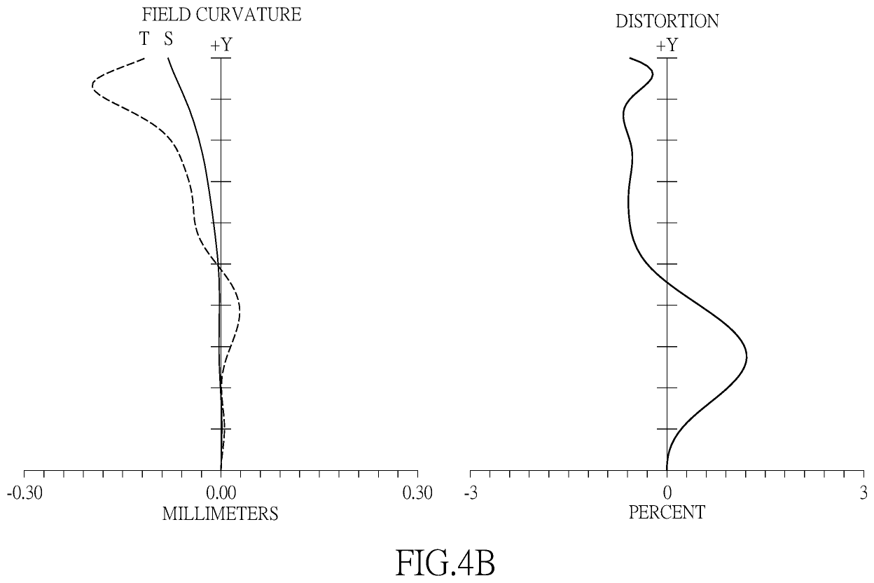

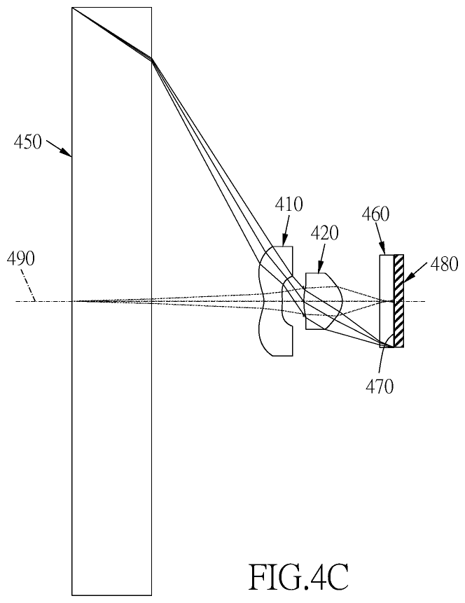

Referring to FIGS. 4A, 4B and 4C, FIG. 4A shows a schematic view of an optical lens assembly in accordance with a fourth embodiment of the present invention, FIG. 4B shows, in order from left to right, the field curvature curve and the distortion curve of the fourth embodiment of the present invention, and FIG. 4C shows a schematic view of an imaging device in accordance with the fourth embodiment of the present invention. As shown in FIG. 4A, the optical lens assembly includes, in order from an object side to an image side: a first lens 410, a stop 400, a second lens 420, an IR-cut filter 460, and an image plane 470. The optical lens assembly has a total of two lenses with refractive power (410, 420), but is not limited thereto. As shown in FIG. 4C, the imaging device includes, in order from an object side to an image side: a flat panel 450, the aforementioned optical lens assembly (not shown) and an image sensor 480 disposed on the image plane 470.

The flat panel 450 is made of glass, is located between an object O and the first lens 410, and has no influence on the focal length of the optical lens assembly. It is understood that the flat panel 450 may be made of other materials.

The first lens 410 with negative refractive power includes an object-side surface 411 and an image-side surface 412, the object-side surface 411 of the first lens 410 is concave in a paraxial region thereof, the image-side surface 412 of the first lens 410 is convex in a paraxial region thereof, the object-side surface 411 and the image-side surface 412 of the first lens 410 are aspheric, and the first lens 410 is made of plastic.

The second lens 420 with positive refractive power includes an object-side surface 421 and an image-side surface 422, the object-side surface 421 of the second lens 420 is convex in a paraxial region thereof, the image-side surface 422 of the second lens 420 is convex in a paraxial region thereof, the object-side surface 421 and the image-side surface 422 of the second lens 420 are aspheric, and the second lens 420 is made of plastic.

The IR-cut filter 460 is made of glass, is located between the second lens 420 and the image plane 470, and has no influence on the focal length of the optical lens assembly.

Please refer to Tables 9-10. The detailed optical data of the respective elements in the optical lens assembly of the fourth embodiment is shown in Table 9, and the aspheric coefficients of the lenses in the fourth embodiment are shown in Table 10.

TABLE 9
Embodiment 4
f = 0.42 mm, Fno = 1.60, FOV = 122.22°

| | | | | | | | Abbe | |
|---|---|---|---|---|---|---|---|---|
| | | Radius of | | | | Refractive | number | Focal |
| Surface | | curvature | | Thickness/gap | Material | index (nd) | (vd) | length |
| 0 | Object | Infinity | | 0.000 | | | | |
| 1 | Flat panel | Infinity | | 1.200 | Glass | 1.52 | 64.2 | |
| 2 | | Infinity | | 1.687 | | | | |
| 3 | First lens | −0.319 | (ASP) | 0.279 | Plastic | 1.54 | 56.0 | −1.39 |
| 4 | | −0.720 | (ASP) | 0.314 | | | | |
| 5 | Stop | Infinity | | 0.008 | | | | |
| 6 | Second | 1.099 | (ASP) | 0.578 | Plastic | 1.54 | 56.0 | 0.57 |
| | lens | | | | | | | |
| 7 | | −0.357 | (ASP) | 0.560 | | | | |

| | | | | | | |
|---|---|---|---|---|---|---|
| 8 | IR-cut filter | Infinity | 0.210 | Glass | 1.52 | 64.2 |
| 9 | | Infinity | 0 | | | |
| 10 | Image | Infinity | — | | | |
| | plane | | | | | |

The reference wavelength is 530 nm.

TABLE 10
Embodiment 4
Aspheric Coefficients

| Surface | 3 | 4 | 6 | 7 |
|---|---|---|---|---|
| K: | 0.0000E+00 | 0.0000E+00 | 0.0000E+00 | 0.0000E+00 |
| A2: | 0.0000E+00 | 0.0000E+00 | 0.0000E+00 | 0.0000E+00 |
| A4: | 1.9226E+00 | 5.4531E+00 | −8.1147E+00 | −5.8328E−01 |
| A6: | −5.7749E+00 | 9.7769E+01 | 3.9157E+02 | 4.9318E+01 |
| A8: | 1.2309E+01 | −3.1863E+03 | −1.1789E+04 | −9.9895E+02 |
| A10: | −1.0976E+01 | 4.5736E+04 | 1.1564E+05 | 1.1891E+04 |
| A12: | −9.6788E+00 | −3.1811E+05 | 1.1321E+06 | −7.2278E+04 |
| A14: | 2.6668E+01 | 7.9651E+05 | −1.4882E+07 | 1.8174E+05 |
| A16: | −4.4947E+00 | 1.9727E+06 | −3.3109E+08 | 3.7046E+05 |
| A18: | −2.2924E+01 | −1.3339E+07 | 5.4417E+09 | −3.5973E+06 |
| A20: | 1.3894E+01 | 1.7716E+07 | −2.2493E+10 | 6.5310E+06 |
| A22: | 0.0000E+00 | 0.0000E+00 | 0.0000E+00 | 0.0000E+00 |
| A24: | 0.0000E+00 | 0.0000E+00 | 0.0000E+00 | 0.0000E+00 |

In the fourth embodiment, the curve equation of the aspheric surface profiles of the aforementioned lenses is the same as the curve equation of the first embodiment. Also, the definitions of these parameters shown in the following table are the same as those stated in the first embodiment, so an explanation in this regard will not be provided again.

These parameters can be calculated from Tables 9-10 as the following values, and the following conditions in Table 11 are satisfied.

TABLE 11
Embodiment 4

| | | | |
|---|---|---|---|
| (R1/R4)*R2[mm] | −0.64 | R3/R4 | −3.08 |
| (R1 + R2)/(R3 + R4) | −1.40 | (FOV/OTL)*R2 | −18.20 |
| CRA/f[°/mm] | 68.42 | f1/T1S | −4.43 |
| CRA*Fno[°] | 45.98 | vd1 + vd2 | 111.97 |
| (R2/f1)*FOV[º] | 63.33 | f1*R3/CT1[mm] | −5.48 |
| (FOV/TG1)*R3[°] | 79.62 | CRA[°] | 28.68 |

### Fifth Embodiment

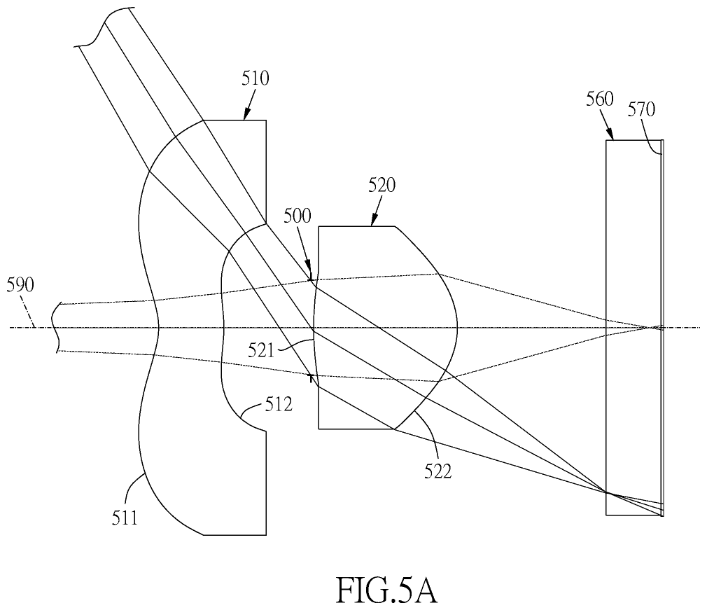

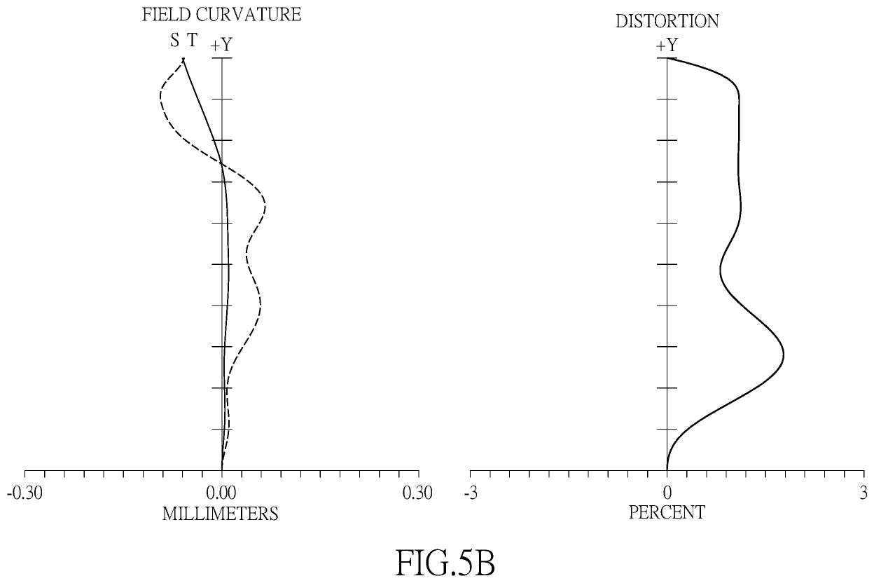

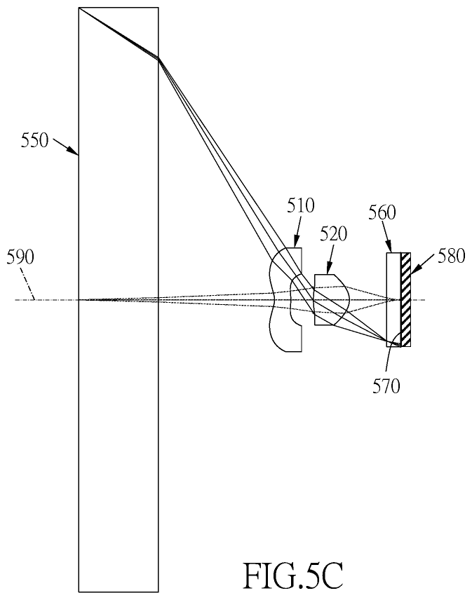

Referring to FIGS. 5A, 5B and 5C, FIG. 5A shows a schematic view of an optical lens assembly in accordance with a fifth embodiment of the present invention, FIG. 5B shows, in order from left to right, the field curvature curve and the distortion curve of the fifth embodiment of the present invention, and FIG. 5C shows a schematic view of an imaging device in accordance with the fifth embodiment of the present invention. As shown in FIG. 5A, the optical lens assembly includes, in order from an object side to an image side: a first lens 510, a stop 500, a second lens 520, an IR-cut filter 560, and an image plane 570. The optical lens assembly has a total of two lenses with refractive power (510, 520), but is not limited thereto. As shown in FIG. 5C, the imaging device includes, in order from an object side to an image side: a flat panel 550, the aforementioned optical lens assembly (not shown) and an image sensor 580 disposed on the image plane 570.

The flat panel 550 is made of glass, is located between an object O and the first lens 510, and has no influence on the focal length of the optical lens assembly. It is understood that the flat panel 550 may be made of other materials.

The first lens 510 with negative refractive power includes an object-side surface 511 and an image-side surface 512, the object-side surface 511 of the first lens 510 is concave in a paraxial region thereof, the image-side surface 512 of the first lens 510 is convex in a paraxial region thereof, the object-side surface 511 and the image-side surface 512 of the first lens 510 are aspheric, and the first lens 510 is made of plastic.

The second lens 520 with positive refractive power includes an object-side surface 521 and an image-side surface 522, the object-side surface 521 of the second lens 520 is convex in a paraxial region thereof, the image-side surface 522 of the second lens 520 is convex in a paraxial region thereof, the object-side surface 521 and the image-side surface 522 of the second lens 520 are aspheric, and the second lens 520 is made of plastic.

The IR-cut filter 560 is made of glass, is located between the second lens 520 and the image plane 570, and has no influence on the focal length of the optical lens assembly.

Please refer to Tables 12-13. The detailed optical data of the respective elements in the optical lens assembly of the fifth embodiment is shown in Table 12, and the aspheric coefficients of the lenses in the fifth embodiment are shown in Table 13.

TABLE 12
Embodiment 5
f = 0.42 mm, Fno = 1.69, FOV = 120.00°

| | | | | | | | Abbe | |
|---|---|---|---|---|---|---|---|---|
| | | Radius of | | | | Refractive | number | Focal |
| Surface | | curvature | | Thickness/gap | Material | index (nd) | (vd) | length |
| 0 | Object | Infinity | | 0.000 | | | | |
| 1 | Flat panel | Infinity | | 1.200 | Glass | 1.52 | 64.2 | |
| 2 | | Infinity | | 1.744 | | | | |
| 3 | First lens | −0.280 | (ASP) | 0.244 | Plastic | 1.54 | 56.0 | −1.69 |
| 4 | | −0.525 | (ASP) | 0.329 | | | | |
| 5 | Stop | Infinity | | 0.010 | | | | |
| 6 | Second | 1.393 | (ASP) | 0.539 | Plastic | 1.54 | 56.0 | 0.57 |
| | lens | | | | | | | |
| 7 | | −0.350 | (ASP) | 0.560 | | | | |

| | | | | | | |
|---|---|---|---|---|---|---|
| 8 | IR-cut filter | Infinity | 0.210 | Glass | 1.52 | 64.2 |
| 9 | | Infinity | 0 | | | |
| 10 | Image | Infinity | — | | | |
| | plane | | | | | |

The reference wavelength is 530 nm.

TABLE 13
Embodiment 5
Aspheric Coefficients

| Surface | 3 | 4 | 6 | 7 |
|---|---|---|---|---|
| K: | 0.0000E+00 | 0.0000E+00 | 0.0000E+00 | 0.0000E+00 |
| A2: | 0.0000E+00 | 0.0000E+00 | 0.0000E+00 | 0.0000E+00 |
| A4: | 2.1320E+00 | 4.7873E+00 | −5.6497E+00 | −8.1112E−01 |
| A6: | −6.0070E+00 | 1.0416E+02 | 3.5502E+02 | 5.5336E+01 |
| A8: | 1.2306E+01 | −3.2038E+03 | −1.1911E+04 | −1.0068E+03 |
| A10: | −1.0831E+01 | 4.5591E+04 | 1.2152E+05 | 1.1741E+04 |
| A12: | −9.5043E+00 | −3.1849E+05 | 1.2903E+06 | −7.4224E+04 |
| A14: | 2.6802E+01 | 7.9979E+05 | −1.3214E+07 | 1.8492E+05 |
| A16: | −4.4162E+00 | 1.9518E+06 | −3.6456E+08 | 4.3728E+05 |
| A18: | −2.2856E+01 | −1.3118E+07 | 3.1458E+09 | −3.2036E+06 |
| A20: | 1.4069E+01 | 1.6432E+07 | 3.7371E+09 | 3.4695E+06 |
| A22: | 0.0000E+00 | 0.0000E+00 | 0.0000E+00 | 0.0000E+00 |
| A24: | 0.0000E+00 | 0.0000E+00 | 0.0000E+00 | 0.0000E+00 |

In the fifth embodiment, the curve equation of the aspheric surface profiles of the aforementioned lenses is the same as the curve equation of the first embodiment. Also, the definitions of these parameters shown in the following table are the same as those stated in the first embodiment, so an explanation in this regard will not be provided again.

These parameters can be calculated from Tables 12-13 as the following values, and the following conditions in Table 14 are satisfied.

TABLE 14
Embodiment 5

| | | | |
|---|---|---|---|
| (R1/R4)*R2[mm] | −0.42 | R3/R4 | −3.98 |
| (R1 + R2)/(R3 + R4) | −0.77 | (FOV/OTL)*R2 | −13.02 |
| CRA/f[°/mm] | 69.69 | f1/T1S | −5.15 |
| CRA*Fno[°] | 49.83 | vd1 + vd2 | 111.97 |
| (R2/f1)*FOV[º] | 37.19 | f1*R3/CT1[mm] | −9.65 |
| (FOV/TG1)*R3[°] | 95.82 | CRA[°] | 29.48 |

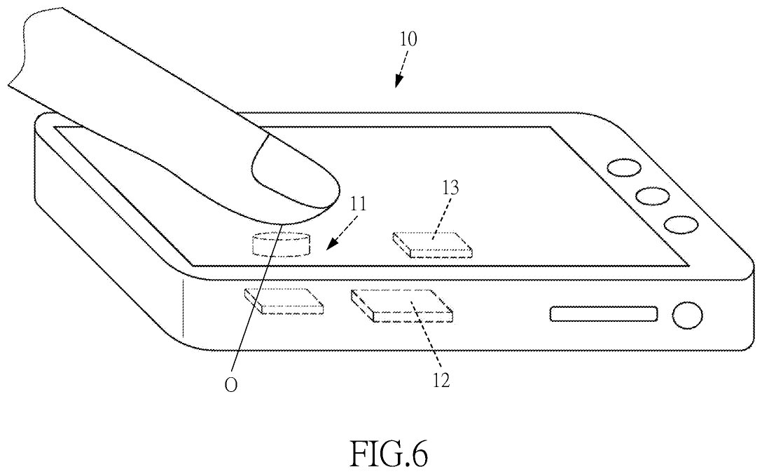

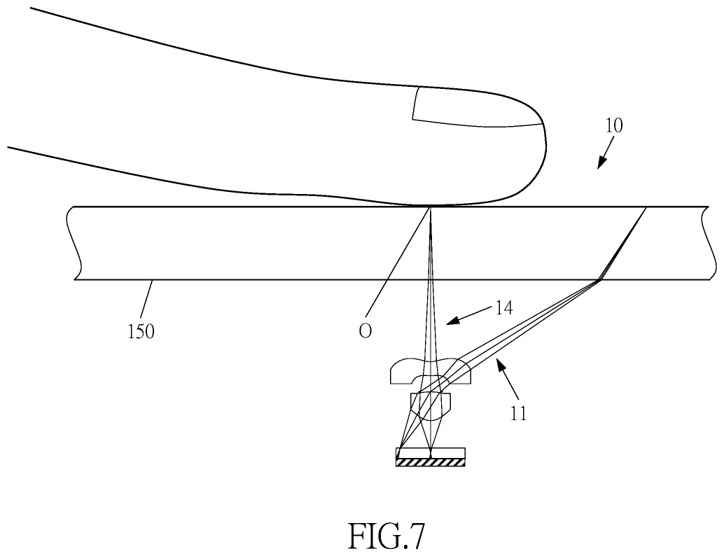

Referring to FIGS. 6 and 7, FIG. 6 is a schematic view showing an imaging device 11 mounted on an electronic device 10 in accordance with the first embodiment of the present invention, but the present invention is not limited thereto. The imaging devices of the above embodiments also can be mounted on the electronic device 10 to make it has a biometric identification system with a fingerprint identification function. FIG. 7 is a side schematic view of FIG. 6. The electronic device 10 includes the imaging device 11, a control unit 12, and a storage unit 13. The control unit 12 is electrically connected to the imaging device 11, and the storage unit 13 is electrically connected to the control unit 12. Preferably, the electronic device 10 may further include a display unit, a temporary storage unit (e.g., RAM), a battery, a communication module, a touch module, a housing or a combination thereof.

For the optical lens assembly in the present invention, the lenses can be made of plastic or glass. If the lens is made of plastic, it is conducive to reducing the manufacturing cost. If the lens is made of glass, it is conducive to enhancing the degree of freedom in the arrangement of refractive power of the optical lens assembly. Moreover, any of the object-side and image-side surfaces of a respective lens of the optical lens assembly can be aspheric, and the aspheric surface can have any profile shape other than the profile shape of a spherical surface, so more variables can be used in the design of aspheric surfaces (than spherical surfaces), which is conducive to reducing the aberration and the number of lenses, as well as the total length of the optical lens assembly.

In the optical lens assembly of the present invention, the IR-cut filter is made of, but not limited to, glass and can be made of other materials with high Abbe numbers.

For the optical lens assembly in the present invention, if the surface shape of a respective lens surface of a respective lens with refractive power is convex and the location of the convex portion of the respective lens surface of the respective lens is not defined, the convex portion is typically located in a paraxial region of the respective lens surface of the respective lens. If the surface shape of a respective lens surface of a respective lens is concave and the location of the concave portion of the respective lens surface of the respective lens is not defined, the concave portion is typically located in a paraxial region of the respective lens surface of the respective lens.

The optical lens assembly of the present invention can be used in electronic devices, such as, digital cameras, mobile devices, tablet computers, smart TVs, 3D image capturing devices, or wearable displays of virtual reality (VR) or augmented reality (AR), according to the actual requirements.

What is claimed is:

1. An optical lens assembly comprising a stop, and in order from an object side to an image side, comprising:
a first lens with negative refractive power, comprising an object-side surface and an image-side surface, the image-side surface of the first lens being convex in a paraxial region thereof, and at least one of the object-side surface and the image-side surface of the first lens being aspheric;
a second lens with positive refractive power, comprising an object-side surface and an image-side surface, the object-side surface of the second lens being convex in a paraxial region thereof, the image-side surface of the second lens being convex in a paraxial region thereof, and at least one of the object-side surface and the image-side surface of the second lens being aspheric;
wherein the optical lens assembly has a total of two lenses with refractive power, a radius of curvature of the object-side surface of the first lens is R1, a radius of curvature of the image-side surface of the first lens is R2, a radius of curvature of the image-side surface of the second lens is R4, and the following condition is satisfied:
$$- 1.45 mm < {( R 1 / R 4 )}^{⋆} R 2 < - 0 \text{.34} mm .$$

2. The optical lens assembly as claimed in claim 1, wherein the radius of curvature of the object-side surface of the first lens is R1, the radius of curvature of the image-side surface of the first lens is R2, a radius of curvature of the object-side surface of the second lens is R3, the radius of curvature of the image-side surface of the second lens is R4, and the following condition is satisfied:
$$- 2.6 < ( R 1 + R 2 ) / ( R 3 + R 4 ) < - 0.62 .$$

3. The optical lens assembly as claimed in claim 1, wherein an incident angle of a chief ray on an image plane at a maximum view angle of the optical lens assembly is CRA, a focal length of the first lens is f1, and the following condition is satisfied:
$$50.53 ° / mm < CRA / f < 86.49 ° / mm .$$

4. The optical lens assembly as claimed in claim 1, wherein an incident angle of a chief ray on an image plane at a maximum view angle of the optical lens assembly is CRA, a f-number of the optical lens assembly is Fno, and the following condition is satisfied: 35.17°<CRA*Fno<90.89°.

5. The optical lens assembly as claimed in claim 1, wherein the radius of curvature of the image-side surface of the first lens is R2, a focal length of the first lens is f1, a maximum field of view of the optical lens assembly is FOV, and the following condition is satisfied: 33.47°<(R2/f1)*FOV<75.51°.

6. The optical lens assembly as claimed in claim 1, wherein a radius of curvature of the object-side surface of the second lens is R3, the radius of curvature of the image-side surface of the second lens is R4, and the following condition is satisfied: −4.77<R3/R4<−1.95.

7. The optical lens assembly as claimed in claim 1, wherein a focal length of the first lens is f1, a distance from the image-side surface of the first lens to the stop along an optical axis is T1S, and the following condition is satisfied: −6.18<f1/T1S<−3.54.

8. The optical lens assembly as claimed in claim 1, wherein an Abbe number of the first lens is vd1, an Abbe number of the second lens is vd2, and the following condition is satisfied: 89.58<vd1+vd2<134.37.

9. The optical lens assembly as claimed in claim 1, wherein a focal length of the first lens is f1, a radius of curvature of the object-side surface of the second lens is R3, a thickness of the first lens along an optical axis is CT1, and the following condition is satisfied: −11.58 mm<f1*R3/CT1<−4.10 mm.

10. An electronic device comprising an imaging device, a control unit electrically connected to the imaging device, and a storage unit electrically connected to the control unit, and the imaging device comprising a stop and in order from an object side to an image side, comprising:
a flat panel;
an optical lens assembly; and
an image sensor;
wherein the optical lens assembly comprises, in order from the object side to the image side:
a first lens with negative refractive power, comprising an object-side surface and an image-side surface, the image-side surface of the first lens being convex in a paraxial region thereof, and at least one of the object-side surface and the image-side surface of the first lens being aspheric;
a second lens with positive refractive power, comprising an object-side surface and an image-side surface, the object-side surface of the second lens being convex in a paraxial region thereof, the image-side surface of the second lens being convex in a paraxial region thereof, and at least one of the object-side surface and the image-side surface of the second lens being aspheric;
wherein the optical lens assembly has a total of two lenses with refractive power, a radius of curvature of the object-side surface of the first lens is R1, a radius of curvature of the image-side surface of the first lens is R2, a radius of curvature of the image-side surface of the second lens is R4, a maximum field of view of the optical lens assembly is FOV, a distance from an object-side surface of the flat panel to an image plane along an optical axis is OTL, and the following conditions are satisfied:
$$- 1.45 mm < ( R 1 / R 4 ) * R 2 < - 0.34 mm and - 25.27 < ( FOV / OTL ) * R 2 < - 11.72 .$$

11. The electronic device as claimed in claim 10, wherein the maximum field of view of the optical lens assembly is FOV, a distance from the flat panel to the first lens along the optical axis is TG1, a radius of curvature of the object-side surface of the second lens is R3, and the following condition is satisfied:
$$61.43 ° < ( FOV / TG 1 ) * R 3 < 105.4 ° .$$

12. The electronic device as claimed in claim 10, wherein an incident angle of a chief ray on the image plane at a maximum view angle of the optical lens assembly is CRA, a focal length of the optical lens assembly is f, and the following condition is satisfied: 50.53°/mm<CRA/f<86.49°/mm.

13. The electronic device as claimed in claim 10, wherein an incident angle of a chief ray on the image plane at a maximum view angle of the optical lens assembly is CRA, a f-number of the optical lens assembly is Fno, and the following condition is satisfied: 35.17°<CRA*Fno<90.89°.

14. The electronic device as claimed in claim 10, wherein a focal length of the first lens is f1, a radius of curvature of the object-side surface of the second lens is R3, a thickness of the first lens along an optical axis is CT1, and the following condition is satisfied: −11.58 mm<f1*R3/CT1<−4.10 mm.

15. The electronic device as claimed in claim 10, wherein an Abbe number of the first lens is vd1, an Abbe number of the second lens is vd2, and the following condition is satisfied: 89.58<vd1+vd2<134.37.

16. The electronic device as claimed in claim 10, wherein the radius of curvature of the object-side surface of the first lens is R1, the radius of curvature of the image-side surface of the first lens is R2, a radius of curvature of the object-side surface of the second lens is R3, the radius of curvature of the image-side surface of the second lens is R4, and the following condition is satisfied:
$$- 2.6 < ( R 1 + R 2 ) / ( R 3 + R 4 ) < - 0.62 .$$

17. The electronic device as claimed in claim 10, wherein the radius of curvature of the image-side surface of the first lens is R2, a focal length of the first lens is f1, the maximum field of view of the optical lens assembly is FOV, and the following condition is satisfied: 33.47°<(R2/f1)*FOV<75.51°.

18. The electronic device as claimed in claim 10, wherein a radius of curvature of the object-side surface of the second lens is R3, the radius of curvature of the image-side surface of the second lens is R4, and the following condition is satisfied:
$$- 4.77 < R 3 / R 4 < - 1.95 .$$

19. The electronic device as claimed in claim 10, wherein a focal length of the first lens is f1, a distance from the image-side surface of the first lens to the stop along an optical axis is T1S, and the following condition is satisfied: −6.18<f1/T1S<−3.54.
